(19) United States
(12) Patent Application Publication
(10) Pub. No.: US 2005/0144010 A1
(43) Pub. Date: Jun. 30, 2005

(54) Interactive language learning method capable of speech recognition

(76) Inventor: Wen Fu Peng, Taipei (TW)

Correspondence Address: PENG WEN FU, P.O. BOX 26-757, TAIPEI, R.O.C. 106, TW

(21) Appl. No.: 10/751,609

(22) Filed: Dec. 31, 2003

(51) Int. Cl. G10L 11/00

(52) U.S. Cl. 704/277

(57) ABSTRACT

The present invention relates to an interactive language learning method capable of speech recognition. The speech recognition technology is applied in the interactive language learning method for analyzing and comparing whether the language practiced by the user is correct. The present invention comprises a repetition mode or a conversation mode. First, this method accesses and plays any language voice data, and waits for a period to let the user input a practice voice signal. Then, the speech recognition is performed to generate the speech recognition data. The speech recognition data and the language voice data are compared to generate a similarity value. Finally, the similarity value and the predetermined adjustment value are compared, and correct/erroneous record regarding the language voice data practiced by the user is stored. Thereafter, all of the correct or erroneous information record regarding the user's practice is compiled.

### BACKGROUND OF THE INVENTION

1. Field of the Invention

The present invention relates to an interactive language learning method capable of speech recognition, and particularly, to an interactive language learning method applying speech recognition technology to analyze and compare whether the practiced language by the user is correct.

2. Description of the Prior Art

Undoubtedly, English is the most popular language in the world. Therefore, good ability in English is necessary for anyone who wants to have a close connection with the world. Self-motivation to learn English is certainly important so as to improve international competition. However, when learning a language, the most critical aspect is conversation. Unless there is a language teacher present to direct conversation and correct a student's pronunciation, the student only can learn listening, reading and writing via books, tapes, or computer software, and not speaking.

Nowadays, various and numerous language teaching products have been developed and marketed. As for the English teaching materials, most of them are focused on the practices of English listening, reading and writing, but the English speaking is not stressed. The main reason is that the user cannot him/herself determine whether his/her speaking is correct, and there is no hardware or software to assist the user in this determination.

In R.O.C. Patent 470904, an interactive teaching system and method is provided. In the disclosure, a network learning system using a computer and an interactive computer learning method is described. A plurality of users can connect to a server, and conduct language learning on the network via the learning system database in the server.

In R.O.C. Patent 472222, a computer-assisted language teaching method and system is provided. Similarly, a computer is used for assisting the user to practice vocabulary, grammar, phrases, and so on. In addition, a speech database is included to speak the correct speech for the user's practice.

However, in the above-mentioned two patents, the provided system and methods cannot assist the user to judge whether his/her speaking is correct. Therefore, in order to resolve the drawbacks of the prior art, the present invention provides an interactive language learning method capable of speech recognition. The present invention applies the popular speech recognition technology to be combined in language learning assistant software or hardware so that the speech recognition can be used for assisting the user to practice speaking.

### SUMMARY OF THE INVENTION

In order to achieve the object of interactive language learning, the present invention provides an interactive language learning method capable of speech recognition for analyzing and comparing whether the language practiced by the user is correct. The present invention has a repetition mode or a conversation mode. First, this method accesses and plays language voice data, and waits for a period to let the user input a practice voice signal. Then, speech recognition is performed to generate speech recognition data. The speech recognition data and the language voice data are compared to generate a similarity value. Finally, the similarity value and the predetermined adjustment value are compared, and the correct or erroneous information record regarding the language voice data practiced by the user is stored. Thereafter, all of the correct or erroneous information record regarding the user's practice is compiled so as to achieve the object of interactive language learning.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a single machine system applying the present invention;

FIG. 2 is a perspective diagram of a network system applying the present invention;

FIG. 3 is a flowchart of a repetition mode according to the first embodiment of the present invention; and

FIG. 4 is a flowchart of a conversation mode according to the second embodiment of the present invention.

### DETAILED DESCRIPTION OF THE PREFERRED EMBODIMENT

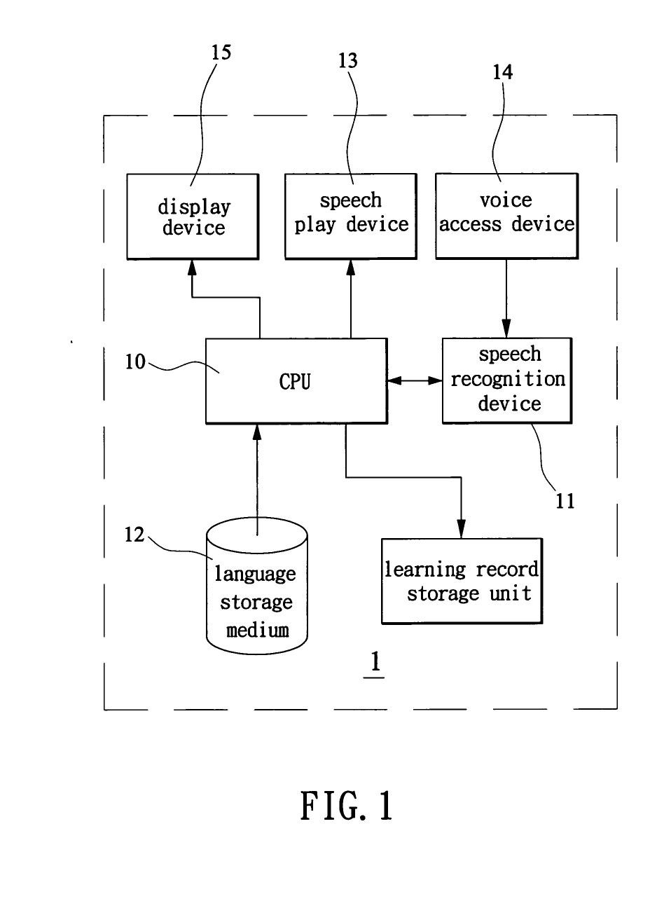

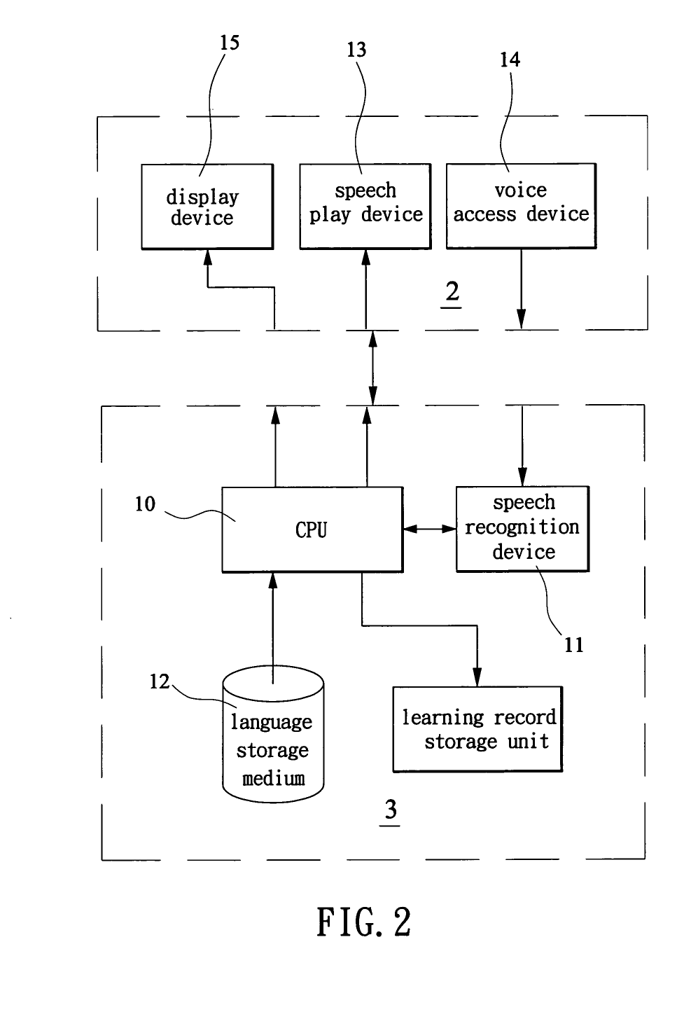

Reference is made to FIG. 1. FIG. 1 is a perspective diagram of a single machine system applying the present invention. FIG. 2 is a perspective diagram of a network system applying the present invention. The interactive language learning method capable of speech recognition is applied in a single machine system 1, such as a personal computer (PC) or a portable language-learning machine. A user can use the single machine system 1 to learn a language. The present invention also can be applied a network system with client-server model. In the network system, a computer 2 is connected to a language-learning main system 3, and therefore, several users can learn the language.

When the present invention is applied in the single machine system 1, the language-learning machine comprises a central processing unit (CPU) 10, a speech recognition device 11, a language storage medium 12, a speech play device 13 and a voice access device 14. When the present invention is applied in the network system, the language learning main system 3 at least comprises a CPU 10, a speech recognition device 11, a language storage medium 12, and the remote computer 2 at least comprises a speech play device 13 and a voice access device 14.

The language storage medium 12 can be a language database or a language file, and is stored with writing and speech data of words, phrases, sentences, or conversations for the purpose of learning languages. The speech play device 13 is used for playing the speech data in the language storage medium 12, and can be a sound card or a speaker. The output end of the sound card can be connected to the speaker, and the voice access device 14 is used for accessing the user's practice voice.

The CPU 10 is used for executing a language-learning program. The program can be used for controlling or recording the user's learning schedule or compiling grades. The speech recognition device 11 is used for recognizing the practice voice input by the user, comparing the same with the speech data stored in the language storage medium 12 and then determining whether the practice voice input by the user is correct.

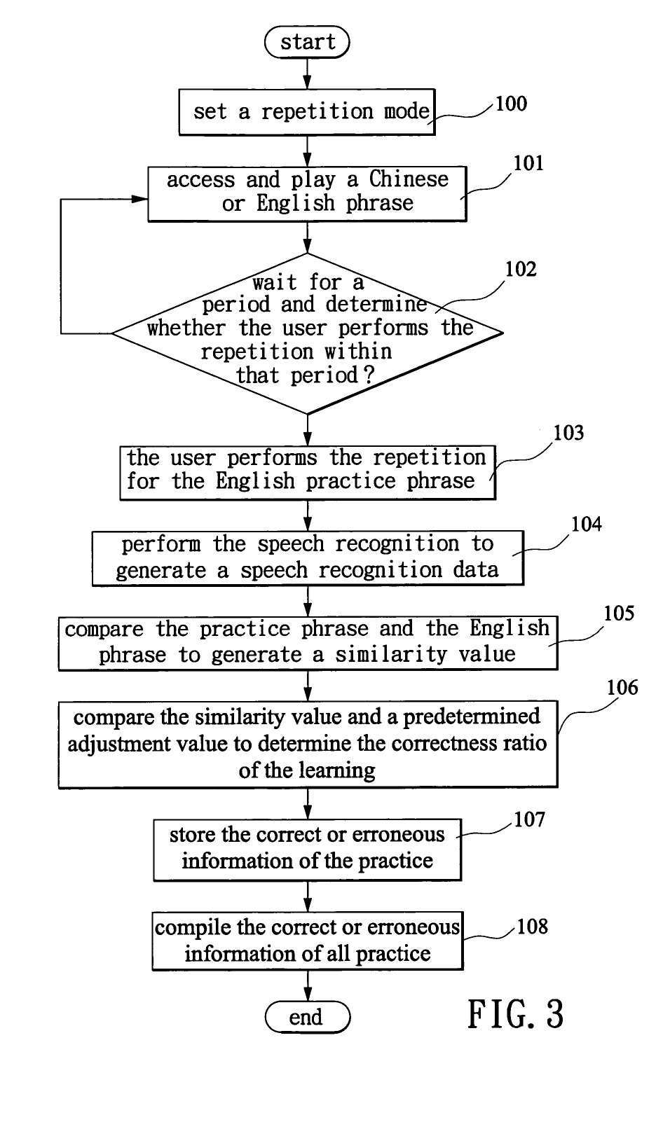

The language-learning program executed by the present invention mainly comprises two learning modes. The first one is a repetition mode, and the second one is a conversation mode. Each mode can comprise two kinds of learning types, for example, the learning type of English repetition or conversation using Chinese, or the learning type of Chinese repetition or conversation using English. Reference is made to FIG. 3. FIG. 3 is a flowchart of a repetition mode according to the first embodiment of the present invention. Before the present invention executes the language-learning program, it is required to set the language learning mode to be the repetition mode or the conversation mode (100).

In the embodiment, first, language voice data stored in the language storage medium 12 is accessed, such as English words or phrases, and the speaker will play the language voice data (101). According to the learning course schedule, the language voice data to be learned is accessed one-by-one. For example, when learning English by using Chinese, the language voice data may comprise English speech and Chinese speech, the Chinese speech corresponding to a translation the English speech. When playing the language voice data, the Chinese speech can be played first, and then the English speech is played. Thereafter, the user can use the microphone to input a practice voice signal, namely, to repeat the English speech.

Then, the present invention will wait for a period (102), such as five seconds. If the user does not repeat the English speech within the five seconds, namely, the practice voice signal is not input within five seconds, this may means that the user did not hear clearly, and therefore, the language voice data will be replayed once so that the user can hear it again. After the user uses the microphone to input the practice voice signal (103), the present invention will perform speech recognition on the practice voice signal to generate speech recognition data (104).

Speech recognition technology has advanced considerably. The most typical ones are speech recognition methods, including the appropriately connecting difference comparison method, the LPC characteristic parameter accessing method, and speech package analysis method. There are hundreds or thousands of papers disclosing related technology, and many researchers had devoted themselves to this field. Nowadays, technology with a 90% recognition rate has been developed. Instead of claiming the related technology of speech recognition, the present invention merely applies the speech recognition technology, and therefore, the speech recognition technology will not be described in detail. Taking the LPC characteristic parameter accessing method for example, the user's practice voice signal is transformed into a speech waveform first, and then the speech waveform is divided into a series of voice frames. Thereafter, a set of linear prediction coefficients is obtained for each of the voice frames. Finally, the characteristic parameter value with high voice wave energy is accessed to generate the speech recognition data.

After the present invention obtains the speech recognition data, the speech recognition data and the language voice data are compared to generate a similarity value (105). Based on this similarity value, the correctness of the language voice data practiced by the user is determined. The comparison method is the same as the speech recognition method. The practice voice signal and the language voice data are both transformed into speech waveforms. At least one characteristic parameter value is accessed from each of the speech waveforms, and then the characteristic parameter values are compared to generate the similarity value.

Finally, the similarity value is compared with a predetermined adjustment value (106). If the similarity value is higher than the predetermined adjustment value, the practice voice signal repeated by the user is similar to the played speech voice data. Therefore, the language learning for this word or phrase is finished. However, if the similarity value is lower than the predetermined adjustment value, the speech representing an error message is generated to ask the user to repeat again. The comparison ratio of the predetermined adjustment value and the similarity value can be adjusted in advance. In the present invention, the ratio can be a high/middle/low comparison correctness ratio. The entry-level user can use the predetermined adjustment value with the low correctness ratio, and the advanced user can use the predetermined adjustment value with the middle/high correctness ratio.

Each time a phrase has been practiced, the present invention will store the correct or erroneous information record of the language voice data practiced by the user (107), and record the serial number and the number of practices or the practice time of the practiced language voice data. After one course or one learning stage is finished, the record of all of the user's practice can be compiled (108). The user's practice will be graded, and a display device 15 will display the grade. The recorded serial number, number of practices, or practice time of the language voice data can be reference data for repeated practice in the future. The serial number of the language voice data with more errors can be reference data having a higher priority for access and play. Also, the serial number of the language voice data of which the practice time has a longer interval can be reference data having a higher priority for access and play.

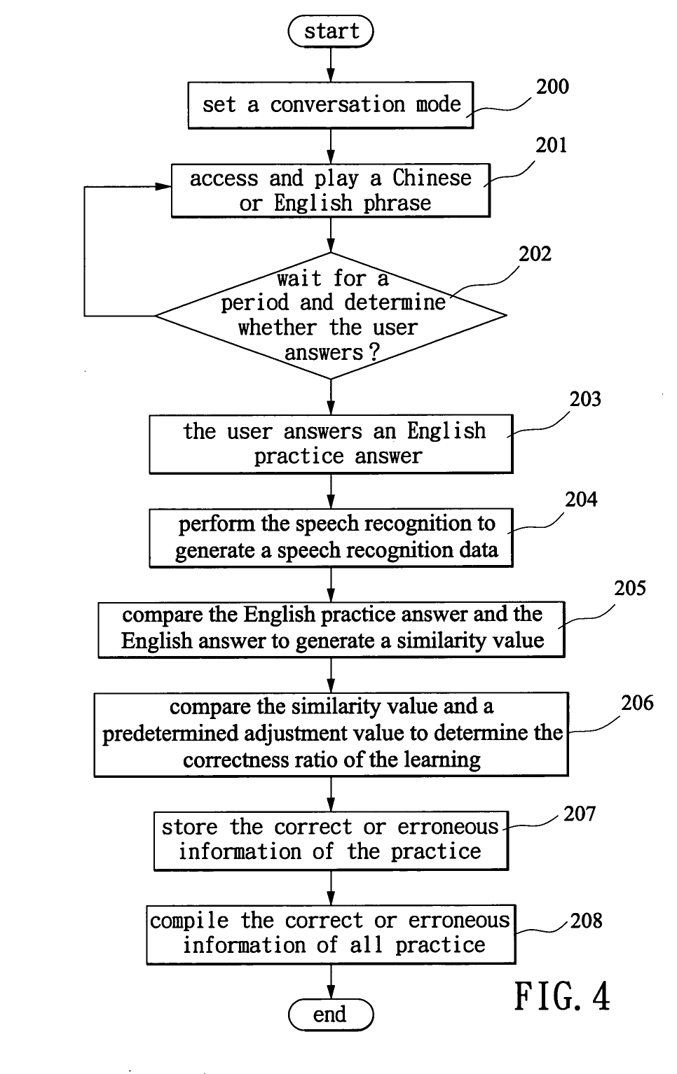

Reference is made to FIG. 4. FIG. 4 is a flowchart of a conversation mode according to the second embodiment of the present invention. The flowchart of the conversation mode according to the present invention is approximately similar to the flowchart of the repetition mode. The difference between the two modes is that the language voice data comprises a question and an answer. The question is played, and the answer is compared to the user's practice voice signal.

In this embodiment, similarly, language voice data stored in the language storage medium 12 is accessed first, and then the speaker plays the language voice data (201). For example, when learning the English using Chinese, the language voice data comprises an English question, a Chinese question, and an English answer. The Chinese question is played first, and then the English question is played. Thereafter, the user uses the microphone to input the answer for the English question.

Next, the present invention will wait for a period (202). After the user uses the microphone to input the practice voice signal (203), the present invention will perform the speech recognition on the practice voice signal to generate speech recognition data (204). Thereafter, the speech recognition data is compared with the language voice data of the English answer to generate a similarity value (205). Finally, the similarity value is compared with the predetermined adjustment value (206), and a record of whether the language voice data practiced by the user is correct/erroneous is stored (207) to compile a record of the user's practice (208).

Those skilled in the art will readily observe that numerous modifications and alterations of the device may be made while retaining the teachings of the invention. Accordingly, the above disclosure should be construed as limited only by the metes and bounds of the appended claims.

1. An interactive language learning method capable of speech recognition, the method at least comprising the following steps:
accessing and playing language voice data;
inputting a user's practice voice signal;
performing speech recognition on the practice voice signal to generate speech recognition data; and
comparing the speech recognition data and the language voice data to generate a similarity value, wherein according to the similarity value, correctness of the user's practice voice signal is determined.

2. The interactive language learning method capable of speech recognition according to claim 1, wherein before the step of accessing the language voice data, the method further comprises the step of:
setting a language learning mode to be a repetition mode or a conversation mode.

3. The interactive language learning method capable of speech recognition according to claim 1, wherein in the step of accessing the language voice data, any language voice data are accessed from a data storage medium.

4. The interactive language learning method capable of speech recognition according to claim 3, wherein in the step of accessing the language voice data, some language voice data are accessed from the data storage medium one-by-one according to the course schedule.

5. The interactive language learning method capable of speech recognition according to claim 1, wherein the language voice data comprises a first speech and a second speech, and the second speech is a translation of the first speech.

6. The interactive language learning method capable of speech recognition according to claim 5, wherein the first speech is in English, and the second speech is in Chinese.

7. The interactive language learning method capable of speech recognition according to claim 1, wherein in the step of playing the language voice data, a speaker is used for playing the language voice data.

8. The interactive language learning method capable of speech recognition according to claim 1, wherein in the step of playing the language voice data, when the language voice data comprises a first speech and a second speech, the second speech is played first, and then the first speech is played.

9. The interactive language learning method capable of speech recognition according to claim 8, wherein the first speech is in English, and the second speech is in Chinese.

10. The interactive language learning method capable of speech recognition according to claim 1, wherein before the step of inputting the user's practice voice signal, the method further comprises the following steps:
waiting for a period; and
playing the language voice data repeatedly if the user does not input the practice voice signal in the period.

11. The interactive language learning method capable of speech recognition according to claim 10, wherein the period is five seconds.

12. The interactive language learning method capable of speech recognition according to claim 1, wherein a microphone is used for inputting the user's practice voice signal.

13. The interactive language learning method capable of speech recognition according to claim 1, wherein the language voice data is a question and an answer, the question is used for playing, and the answer is used for comparison with the user's practice voice signal.

14. The interactive language learning method capable of speech recognition according to claim 13, wherein the question is an English question or a Chinese question.

15. The interactive language learning method capable of speech recognition according to claim 13, wherein the answer is an English answer or a Chinese answer.

16. The interactive language learning method capable of speech recognition according to claim 1, wherein in the step of performing speech recognition on the practice voice signal, the following steps are further comprised:
transforming the practice voice signal into a speech waveform; and
accessing at least one characteristic parameter value from the speech waveform to generate speech recognition data.

17. The interactive language learning method capable of speech recognition according to claim 1, wherein in the step of comparing the speech recognition data and the language voice data, the following steps are further comprised:
transforming the practice voice signal and the language voice data into speech waveforms;
accessing at least one characteristic parameter value from each of the speech waveforms, and then determining whether the characteristic parameter values are similar to each other to generate a similarity value.

18. The interactive language learning method capable of speech recognition according to claim 1, wherein after the step of comparing the speech recognition data and the language voice data, the method further comprises:
comparing the similarity value and a predetermined adjustment value;
finishing the language learning if the similarity value is higher than the predetermined adjustment value; and
generating an error message to ask the user to re-input the practice voice signal if the similarity value is lower than the predetermined adjustment value.

19. The interactive language learning method capable of speech recognition 10 according to claim 18, wherein the predetermined adjustment value can adjust and compare the ratio of the similarity value in advance and the ratio can be a high/middle/low comparison correctness ratio.

20. The interactive language learning method capable of speech recognition according to claim 1, wherein after the step of comparing the speech recognition data and the language voice data, the method further comprises a step of storing a correct/erroneous record of the language voice data practiced by the user, and recording a serial number, number of practices, or practice time of the language voice data.

21. The interactive language learning method capable of speech recognition according to claim 20, wherein after the step of storing, comparing and recording, the method further comprises the step of compiling all correct/erroneous records of the language voice data practiced by the user, and after grading, a display device displays the grading result.

22. The interactive language learning method capable of speech recognition according to claim 21, wherein the recorded serial number, number of practices, or practice time of the language voice data are reference data for repeated practice in the future.

23. The interactive language learning method capable of speech recognition according to claim 22, wherein as the reference data of the repeated practice, the serial number of the language voice data with more errors has a higher priority for access and play.

24. The interactive language learning method capable of speech recognition according to claim 22, wherein as the reference data of the repeated practice, the serial number of the language voice data for practice time with a longer interval has a higher priority for access and play.
